(19) United States
(12) Patent Application Publication
(10) Pub. No.: US 2011/0094240 A1
(43) Pub. Date: Apr. 28, 2011

(54) Swirl Generator

(75) Inventors: Holger HUITENGA, Mulheim (DE); Jaman El Masalme, Hamminkeln (DE); Emil Aschenbruck, Duisburg (DE); Reiner Brinkmann, Duisburg (DE)

(73) Assignee: MAN Diesel & Turbo SE, Augsburg (DE)

(21) Appl. No.: 12/910,283

(22) Filed: Oct. 22, 2010

(30) Foreign Application Priority Data
Oct. 23, 2009 (DE) 10 2009 045 950.2

(51) Int. Cl. F02C 7/22

(52) U.S. Cl. 60/776; 60/737; 60/748

(57) ABSTRACT

A swirl generator for injecting fuel into a gas turbine by injection of the fuel into a channel of the swirl generator of the gas turbine. The fuel injection is predetermined by the arrangement of a fuel injecting insert in a swirl generator segment.

### BACKGROUND OF THE INVENTION

1. Field of the Invention

The present invention is directed to a swirl generator and a method for injecting fuel into a gas turbine.

2. Description of the Related Art

For low-emissions combustion of gaseous fuels with air, it is known to impart a rotational momentum to the supplied combustion air through a swirl generator and to inject fuel into the air flow in this swirl generator in order to achieve an optimal premixing of fuel and air.

WO 2004/057236 A2 shows fuel outlets in an upstream cover of the swirl generator, and EP 1 890 083 A1 shows fuel outlets in a downstream base of the swirl generator.

To enable the injection of fuel over the entire channel height of the swirl generator, EP 0 728 989 B1 and EP 0 718 550 B1 propose stationary fuel lances arranged in the channels between swirl generator segments and guide vanes of the swirl generator.

To prevent flow losses, it is also known, for example, from WO 2007/093248 A1, WO 2008/141955 A1, WO 2007/033876 A1 and EP 0 870 989 B1, to form fuel feed lines and outlets by bore holes in the swirl generator segments.

While the fuel outlets in these swirl generators are formed in lateral channel walls of the swirl generator segments, WO 2007/131818 A1 proposes front fuel outlets in axial shoulders of the swirl generator segments.

Finally, EP 1 892 469 A1 discloses a swirl generator with a plurality of wedge-shaped swirl generator segments in which are formed fuel-supplying axial bore holes and, parallel thereto, air-supplying axial bore holes. The air-supplying bore holes communicate with a bore hole in a side wall of the channel defined by the swirl generator segment, this bore hole opening into the air-supplying bore hole at right angles to inject additional combustion air into the channel. A hollow tube having a small diameter is inserted into this larger bore hole so as to meet the fuel-supplying axial bore hole at right angles so that fuel is injected into the channel through this fuel injection insert in the interior of the annular additional-air feed.

### SUMMARY OF THE INVENTION

In the above-cited prior art, the fuel injection through the fuel outlets is always determined at the design stage. However, the mixing of fuel and combustion air that depends upon the injection of fuel is very sensitive, particularly with respect to the properties of the combustion gas, for example, its composition, density, and caloric value, and also with regard to the air throughput which varies with different outputs of the gas turbine. Therefore, the solutions mentioned above, whose fuel injections were designed to be optimized for certain boundary conditions and were then fixed, only work suboptimally when boundary conditions change, for example, when the fuel or the air throughput changes.

Therefore, it is an object of the present invention to improve the mixing of fuel with combustion air in a swirl generator of a gas turbine.

In one embodiment of the invention the injection of fuel into a channel of a swirl generator of a gas turbine is defined by a variable arrangement of fuel injecting inserts in air-guiding swirl generator segments of the swirl generator. By changing the arrangement of fuel injecting inserts in the swirl generator segments, the injection of fuel can be adapted to different fuel properties or air throughputs.

According to one embodiment of the present invention, diverse fuel injecting inserts having different fuel outlets can be arranged as desired in a swirl generator segment. For example, two fuel injecting inserts which can be arranged alternatively in a swirl generator segment can differ with respect to the quantity, shape, size, position, and/or direction of one or more fuel outlets. A plurality of fuel outlets of a fuel injecting insert can be constructed identically or differently, can be equidistant or at different distances in direction of the channel height, and/or can be arranged offset relative to one another at an angle or one below the other on the lateral surface of the fuel injecting insert.

In a preferred construction, the fuel injecting inserts can be received in the swirl generator segments with a predetermined orientation to define an injecting direction of the fuel in which the fuel exits from the fuel injecting insert into the channel, which injecting direction has a predetermined angle relative to a longitudinal axis of the swirl generator and/or relative to an air flow in the channel, i.e., in axial section or cross section, and which is oriented in a preferred construction substantially perpendicular to the longitudinal axis and/or to the air flow but which can also have a component oriented in opposition to a through-flow direction of the channel to improve the mixing of the injected fuel with the swirled air by the formation of a stagnation point and resulting swirling of air. The fuel injecting inserts can be received in the swirl generator segments particularly so as to be fixed with respect to rotation relative to them, preferably by positive engagement.

According to one embodiment of the invention, the injection of fuel into the channel can also be determined by the arrangement of the fuel injecting insert in the swirl generator segment in that the same fuel injecting insert can be received in a swirl generator segment with an orientation which can be variously defined.

The fuel injecting insert can be constructed in a rotationally symmetrical manner and can be arranged in a corresponding hollow space of the swirl generator, where it can be secured permanently or detachably by frictional engagement or material bond, e.g., by welding, in an optional orientation or angular position with respect to its axis of symmetry. Similarly, the fuel injecting insert can also have a geometry with a break in the rotational symmetry so that it can be inserted into the swirl generator segment in only one or more selected angular positions.

Both aspects can be combined in an advantageous manner in that one of a plurality of different fuel injecting inserts is alternatively inserted in a swirl generator segment electively in one of a plurality of possible orientations.

In a preferred construction, a fuel injecting insert is arranged in one or more inlet edges of a swirl generator segment. In this way, it is advantageously possible to arrange fuel outlets in the vicinity of a channel inlet to improve mixing with the injected fuel through the swirling of the air taking place at that location and by making use of the entire channel of the swirl generator as a mixing section. For this purpose, a fuel injecting insert can be inserted, particularly by positive engagement, into a cutout in the inlet edge of the swirl generator segment, which cutout opens outward toward the channel, so that the inlet contour of the channel or the inlet edge of the swirl generator segment is formed at least partially by the inserted fuel injecting insert. By varying its orientation or exchanging it for a different kind of fuel injecting insert according to the first aspect and second aspect mentioned above, the inlet contour of the channel can also be adapted to altered boundary conditions in this way. Further, by a fuel injecting insert arranged in an inlet edge of a swirl generator segment, this inlet edge can be constructed with a material, namely, that of the fuel injecting insert, which is different than the rest of the swirl generator segment whose walls define the lateral surfaces of the channel.

A fuel injecting insert is preferably received at least partially in the swirl generator segment, i.e., not along its entire lateral surface, and free areas of its lateral surface have fuel outlets and/or at least partially form an inlet edge of the swirl generator segment. To this extent, fuel injecting insert received in a swirl generator segment is also a fuel injecting insert which is at least partially received in the swirl generator segment.

In a preferred construction, a fuel injecting insert is received in a swirl generator segment so as to be exchangeable to define the injection of fuel into a channel by reorientation or by exchanging with another fuel injecting insert. The exchangeable fuel injecting insert can be secured, for example, by frictional engagement, e.g., by screwing a cover on to the swirl generator segment, or by a material bond, e.g., by welding the fuel injecting insert to the swirl generator segment, in which case exchangeability is advantageously ensured by forming predetermined breaking points in the material bond connection.

A material bond connection, is additionally or alternatively provided by flexible sealings, for example, C-rings are produced from metal in a preferred construction in view of the temperatures to which a swirl generator is exposed during operation of the gas turbine, a fuel injecting insert can be sealed relative to the swirl generator segment receiving it and/or relative to a cover in which a fuel feed to the fuel injecting insert can be formed.

According to one embodiment of the present invention, which can preferably be combined with the first and/or second aspect, a swirl generator has a plurality of swirl generator segments for injecting fuel in a gas turbine, channels being formed between the plurality of swirl generator segments for supplying swirled air to a combustion chamber of the gas turbine, and the swirl generator segments are arranged in the swirl generator so as to be exchangeable.

Accordingly, as was mentioned above with respect to the first aspect, the swirl generator can be adapted to different properties of the combustion gas or to an air throughput which varies with different outputs of the gas turbine by electively inserting different swirl generator segments which can differ from one another, for example, with respect to height, width and/or the shape of the channels of the swirl generator which are defined by them, quantity, shape, size and/or arrangement of fuel outlets provided therein or fuel injecting inserts received therein.

The present invention is applied in a particularly advantageous manner in stationary gas turbines, radial swirlers and/or for the injection of gaseous fuel.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Other advantages and features are indicated in the subclaims and the embodiment example explained in the following. The partially schematic drawings show:

FIG. 1 is a cross section through one half of a swirl generator according to a construction of the present invention along section line I-I in FIG. 2;

FIG. 2 is an axial section through one half of the swirl generator according to FIG. 1 along section line II-II; and

FIGS. 3A, 3B are two different fuel injecting inserts for the swirl generator according to FIG. 1.

### DETAILED DESCRIPTION OF THE PRESENTLY PREFERRED EMBODIMENTS

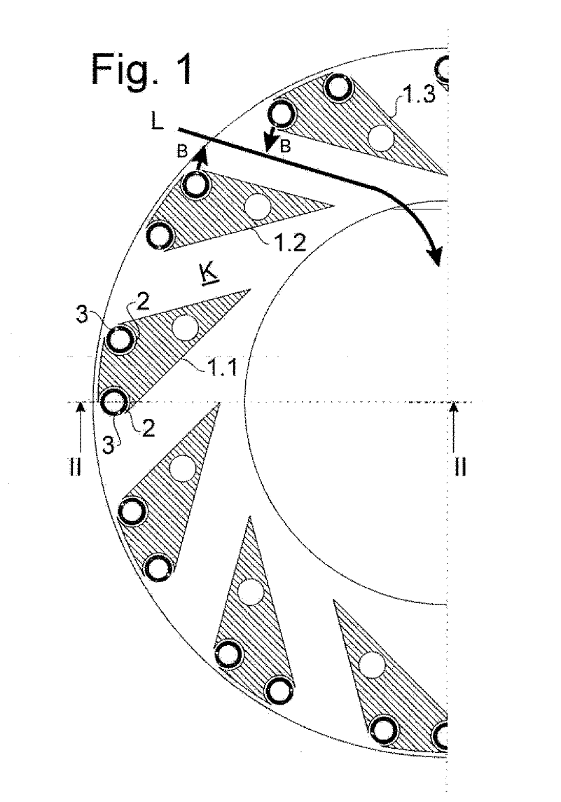

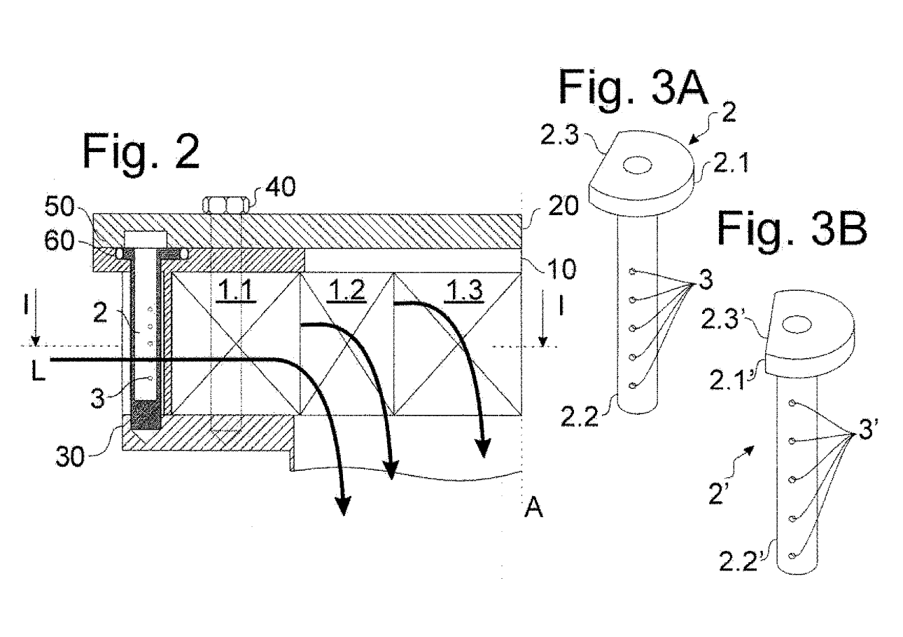

FIGS. 1 and 2 show one half of a radial swirl generator according to an embodiment of the present invention in cross section and axial section.

Channels K are formed between wedge-shaped swirl generator segments 1.1, 1.2, 1.3 having a substantially triangular cross section to supply combustion air L to a combustion chamber of a stationary gas turbine (not shown), this combustion chamber being situated (at bottom in FIG. 2) on the radially inner side, axially downstream in the flow direction of the swirl generator. By the deflection, a rotational momentum is applied to the combustion air whose flow line is indicated by the bold arrows in FIGS. 1 and 2.

Rotationally symmetrical bore holes that open outward are formed in the two radially outer corners of the swirl generator segments 1.1, 1.2, 1.3, respectively. A cylindrical insert body 2.2 or 2.2′ (see FIG. 3) of a fuel injecting insert 2 or 2′ is inserted into the bore holes in a positive engagement so that about three-fourths of its lateral surface is received in the complementary three-fourths circular bore hole. In a modification, not shown, the insert body can also be arranged deeper inside the swirl generator segment so that a larger portion of its lateral surface is received in the complementary bore hole which can then extend over more than one three-fourths circle. In one embodiment, the insert body can also be arranged at a lesser depth in the swirl generator segment so that a smaller portion of its lateral surface is received in the complementary bore hole which then extends over less than a three-fourths circle in a corresponding manner.

A substantially circular disk-shaped insert head 2.1 or 2.1′ which is flattened on a flat side 2.3 and 2.3′, respectively, (FIG. 3) adjoins the cylindrical insert body 2.2, 2.2′.

Complementary circular cutouts with a flattened circle chord are formed in a cover ring 10 (see FIG. 2) at which the swirl generator segments 1.1, 1.2, 1.3 are formed integral therewith or, in a modification which is not shown, to which they are secured by a material bond or by frictional engagement, so that the fuel injecting inserts 2, 2′ can only be inserted into the swirl generator segments 1.1, 1.2, 1.3 in an orientation that is predetermined by the flat side 2.3 and 2.3′, respectively. They are attached in these swirl generator segments 1.1, 1.2, 1.3 by a weld seam so as to be detachable again and, in addition, are sealed relative to the cover ring 10 by metal C-rings 60.

A cover 20 of the swirl generator is screwed to the cover ring 10, an annular fuel feed 50 which is open toward the insert heads 2.1 and 2.1′, respectively (see FIG. 3) of the fuel injecting inserts being formed in the cover 20. To this end, screws 40 pass through the cover 20, the cover ring 10 and the swirl generator segments 1.1, 1.2, 1.3 and are screwed into a swirl generator base 30 which, together with the cover ring 10 and the side walls of the swirl generator segments 1.1, 1.2, 1.3, defines the air supply channels K and into which the insert bodies 2.2 and 2.2′ of the fuel injecting inserts 2 and 2′ are inserted at the front (see FIG. 2). The cover 20 also secures the fuel injecting inserts by positive engagement and frictional engagement.

The fuel injecting inserts have an axial bore hole (see FIG. 2) that opens toward the insert head, and radial bore holes 3 communicating with this axial bore hole. Gaseous fuel supplied to the fuel injecting inserts 2 via the fuel feed line 50 flows through the longitudinal or axial bore hole in the insert head and is injected into the channel K through the radial bore holes 3 functioning as fuel outlets.

Since the inserted fuel injecting insert is fixed with respect to rotation in the respective swirl generator segment with a predetermined orientation owing to the flattening of the insert head and the correspondingly complementary cutout in the cover ring 10 of the swirl generator segments, the position of the fuel outlets 3 relative to the flattened portion 2.3 and 2.3′ of the insert head 2.1 and 2.1′, respectively, determines an injection direction in cross section, i.e., relative to the air flow L, when the fuel injecting insert is inserted into the swirl generator segment. In the fuel injecting inserts 2 (FIG. 3A), the fuel outlets 3 are arranged relative to the flattened portion 2.3 of the insert head 2.1 in such a way that, as is shown in FIG. 1, the fuel B is injected substantially perpendicular to the air flow L when the fuel injecting insert 2 is inserted.

In fuel injecting insert 2′ (FIG. 3B), the fuel outlets 3′ are offset relative to the flattened portion 2.3′ of the insert head 2.1′ such that the injection direction of the fuel in the channel has a component that is oriented opposite the throughflow direction, i.e., radially outward, when fuel injecting insert 2′ is inserted into a swirl generator segment so as to be fixed with respect to rotation relative to it instead of fuel injecting insert 2 with the orientation predetermined by the flattened portion 2.3′ and is attached by welding. This injection opposite the air flow of the combustion air can improve the mixing with the injected fuel, particularly at a lower air throughput, by stagnation points in the flow of the combustion air L which are formed in front of the fuel outlets 3′.

As is shown by comparing FIGS. 3A and 3B, the fuel outlets 3, 3′ differ not only in their angular position relative to the flattened portion 2.1 and 2.3′, respectively, but also in the height at which they are arranged in the channel K.

Accordingly, by exchanging or electively inserting the fuel injecting inserts 2 or 2′, the injection of fuel can be specified and adapted to changed properties of the combustion gas or to a varying air throughput. Instead of the fuel injecting inserts 2 and 2′ which are shown in the drawing, it is also possible to use other fuel injecting inserts, not shown, which have fuel outlets of a different shape, quantity and/or outlet direction so that, for example, an injection direction which is not horizontal with respect to FIG. 2 can be realized in that the fuel outlet axis forms an angle not equal to 90° with the longitudinal axis of the fuel injecting insert.

In one embodiment, the cutouts in the cover ring 10 for receiving the insert heads of the fuel injecting inserts are formed so as to be completely rotationally symmetrical and accordingly allow the fuel injecting inserts to be received in the swirl generator segments with any predefinable orientation relative to their longitudinal axis or axis of symmetry. The fuel injection can also be predetermined in any desired manner in that the fuel injecting inserts are rotated in such a way when inserting them into the swirl generator segments, or after inserting them into the swirl generator segments, that their fuel outlets 3 and 3′ impart a desired injection direction and are subsequently fixed with respect to rotation in this angular position, e.g., by welding with the cover ring 10.

In one embodiment, the insert heads 2.1 and 2.1′ of the fuel injecting inserts 2 and/or 2′ and the cutouts in the cover ring 10 which receive them are constructed in such a way that they allow the fuel injecting inserts to be received in the swirl generator segments with different discrete orientations which are offset relative to one another at an angle around their longitudinal axis. For example, the insert heads and the cutouts receiving them can have a cross section in the shape of a regular polyhedron, e.g., a regular 36-sided polyhedron, so that they can be received so as to be offset by 10°, respectively, and fixed with respect to relative rotation.

In the preferred embodiment, the fuel injecting inserts are arranged in the radially outer inlet edges of the swirl generator segments. This advantageously combines a rounded channel inlet through the cylindrical insert body 2.1 and 2.2′ of the fuel injecting inserts, protection of the inserts against mechanical environmental influences, a favorable thermal impact upon the inserts, and an advantageous injection of the fuel at, or—depending upon the angular position—in front of, the edge inlet so that the entire channel is used as a mixing section.

Accordingly, the fuel injecting inserts arranged in the inlet edges of a swirl generator segment advantageously form a portion of the surface of the swirl generator segment and accordingly likewise make it possible to integrate the fuel injecting inserts in the swirl generator segments in a compact manner and to vary their outer contour. For example, like the insert head, the insert body of another fuel injecting insert, not shown, can have a flattened portion in which the fuel outlets are formed. By inserting these fuel injecting inserts instead of the inserts with cylindrical insert bodies 2.2 and 2.2′ shown in FIGS. 3A, 3B, the inlet edges of the swirl generator segments can be represented by a run-in bevel which is formed by the flattened portion of the insert body and takes the place of the run-in radius which is formed by the lateral surface of the cylindrical insert body 2.2 and 2.2′.

Instead of the cover ring 10 and the swirl generator segments 1.1, 1.2, 1.3 which are originally formed, e.g., cast, with them, another cover ring, whose swirl generator segments differ from the swirl generator segments 1.1, 1.2, 1.3 shown in FIGS. 1 and 2 with respect to the shape of the lateral surfaces of the channel, the channel height, the arrangement of fuel injecting inserts, or the like, can be screwed to the cover 20 and the swirl generator base 30 so that the channel shape, channel height, and/or quantity of channels in the swirl generator can also be varied like the fuel injection.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A radial swirl generator, configured to inject fuel in a gas turbine, comprising:
a plurality of swirl generator segments;
a channel being formed between each two adjacent plural swirl generator segments configured to supply swirled air to a combustion chamber of the gas turbine; and
a plurality of fuel injecting inserts configured to inject fuel into respective channels to premix air and fuel each received in a respective swirl generator segment,
wherein the injection of fuel into a respective channel can be predetermined by the arrangement of a respective fuel injecting insert in a respective swirl generator segment.

2. The swirl generator according to claim 1, wherein an injection direction of the fuel in each channel is oriented at a predetermined angle to one of a longitudinal axis of the swirl generator and an air flow.

3. The swirl generator according to claim 2, wherein the injection direction of the fuel in the channel has a component oriented in opposition to a through-flow direction of the channel.

4. The swirl generator according to claim 1, wherein one of a plurality of different fuel injecting inserts each having different fuel outlets is received in the swirl generator segment.

5. The swirl generator according to one of the preceding claims, wherein each fuel injecting insert comprises a swirl generator segment with at least one of a predetermined height and a predetermined nozzle orifice.

6. The swirl generator according to claim 1, wherein each fuel injecting insert is configured to be received in a respective swirl generator segment with a respective predetermined orientation.

7. The swirl generator according to claim 6, wherein each fuel injecting insert is configured to be received in the swirl generator segment with a plurality of orientations.

8. The swirl generator according to claim 1, wherein each fuel injecting insert is received in a respective swirl generator segment so as to be fixed by positive engagement with respect to rotation relative to it.

9. The swirl generator according to claim 1, further comprising a cover in which a fuel feed to the fuel injecting inserts is provided, wherein the fuel injecting insert is sealed relative to one of the cover and to the respective swirl generator segment receiving it.

10. The swirl generator according to one of the preceding claims, wherein a respective fuel injecting insert is arranged in an inlet edge of a respective swirl generator segment.

11. The swirl generator according to claim 10, wherein the fuel injecting insert at least partially forms the inlet edge of the swirl generator segment.

12. The swirl generator according to claim 1, wherein a fuel outlet is arranged one of in front of a respective channel inlet and at the respective channel inlet.

13. The swirl generator according to claim 1, wherein a respective fuel injecting insert is exchangeably received in a respective swirl generator segment.

14. The swirl generator according to claim 1, wherein the plural swirl generator segments are exchangeably arranged in the swirl generator.

15. The swirl generator according to claim 1, wherein the fuel injecting insert comprises:
a rotationally symmetrical insert body configured to be received in a hollow space of a respective swirl generator segment opening toward the channel, the insert body comprising a longitudinal bore hole and at least one fuel outlet communicating with the longitudinal bore hole.

16. The swirl generator according to claim 15, wherein the fuel injecting insert comprises an insert head configured to be received in the swirl generator by positive engagement fixed with respect to relative rotation.

17. The swirl generator according to claim 1, wherein the swirl generator segment comprises a hollow space opening toward the channel for receiving a respective fuel injecting insert,
wherein an injection of the fuel by a fuel injecting insert into a channel can be predetermined by the arrangement of the fuel injecting insert in the swirl generator segment.

18. The swirl generator according to claim 17, wherein each swirl generator segment has a substantially triangular cross section and two corners form inlet edges.

19. The swirl generator according to claim 1, wherein the swirl generator is incorporated into a stationary gas turbine.

20. A method for injecting fuel into a gas turbine comprising:
determining based at least in part on an arrangement of a fuel injecting insert in a swirl generator segment; and
injecting the fuel into a channel of the swirl generator of the gas turbine.
